(19) United States
(12) Patent Application Publication
(10) Pub. No.: US 2006/0175871 A1
(43) Pub. Date: Aug. 10, 2006

(54) Motor vehicle body

(76) Inventors: Konrad Eipper, Rottenburg (DE); Wolfgang Fussnegger, Tuebingen (DE); Christian Mayer, Renningen (DE); Bernhard Spies, Sindelfingen (DE); Carlos Valdivieso, Tiefenbronn (DE)

Correspondence Address: KENYON & KENYON LLP, ONE BROADWAY, NEW YORK, NY, 10004, US

(21) Appl. No.: 10/526,122

(22) PCT Filed: Aug. 8, 2003
(86) PCT No.: PCT/EP03/08817

§ 371 Date: Oct. 21, 2005

(30) Foreign Application Priority Data
Aug. 27, 2002 (DE) 102 39 988.3

(51) Int. Cl. B62D 25/06

(52) U.S. Cl. 296/193.04; 296/193.12

(57) ABSTRACT

A motor vehicle body, having a roof module which is placed onto a support structure and is adjoined by a lid (engine hood) for closing a space (engine compartment on an end region of the body, the lid being held on the body via a bearing arrangement in the vicinity of the roof module. In order to position the lid in relation to the adjacent roof module with relatively little technical outlay, the bearing arrangement is arranged directly on the roof module and can therefore already be prefitted to the roof module before the roof module is placed onto the support structure.

### FIELD OF THE INVENTION

The invention relates to a motor vehicle body.

### BACKGROUND INFORMATION

A supporting structure having a roof module which is placed onto it and which is adjoined by an engine hood mounted in the vicinity of the roof is known from U.S. Pat. No. 6,334,252. In this case, the bearing arrangement of the engine hood is arranged directly on the roof module and can therefore be already prefitted to the roof module before the roof module is placed onto the supporting structure. Arranged above a structural component comprising—a longitudinal member and a wheel housing plate—are two lateral bearing consoles for the bearing arrangement, which bearing consoles run above the wheel housing. In this case, the roof columns are supported on supporting surfaces of the door pillars, and the bearing consoles are supported on supporting surfaces of the structural component of the supporting structures.

A body which is assembled essentially from large-size partial modules, a roof module is placed, is already known from German Patent No. 35 40 814. In the assembled state of the body, the front, lower end of the roof module is adjoined by an engine hood for closing the engine compartment on the front end region of the body, the lid being held on the body via a bearing arrangement arranged in the vicinity of the roof module. In this case, on account of manufacturing tolerances when joining the roof module to the other partial modules, it is possible only with an increased technical outlay to position the engine hood or similar lid, which is fastened to the support structure, precisely in relation to the adjacent roof module.

The present invention is based on the object of providing a body in which the lid can be positioned in relation to the adjacent roof module with relatively little technical outlay.

In the case of the body proposed according to the invention, the bearing arrangement of the lid or of the engine hood is arranged directly on the roof module, so that the lid can be positioned precisely relative to the adjacent roof module in a relatively simple manner and with a high-quality impression being conveyed. Manufacturing tolerances which arise when the roof module is joined to the support structure therefore have no effect on the position of the lid relative to the adjacent roof module.

A technically particularly favorable bearing arrangement comprises in each case a bearing which is fastened to the associated roof column of the roof module, via which a positionally precise and stable mounting of the lid on the roof module can be ensured.

A particularly stable support of the bearing is provided by means of bearing consoles which are arranged at the lower ends of the roof columns as an extension thereof. In this case, the bearing consoles preferably rest on supporting surfaces of the support structure, so that both a good supporting of the bearing consoles with the bearings and of the entire roof module is achieved via the roof columns.

### BRIEF DESCRIPTION OF THE DRAWINGS

FIG. 1 shows a perspective exploded illustration of the support structure of the motor vehicle body according to the invention, which support structure is assembled from large-size partial modules

FIG. 2 shows a further perspective exploded illustration of the support structure which is assembled from partial modules and is lined with outer panel parts.

FIG. 3 shows a perspective view of a roof module, the front roof columns of which comprise at their lower end bearing consoles for the bearing arrangement of the engine hood.

FIG. 4 shows an enlarged side view of a bearing of the bearing arrangement for the engine hood.

### DETAILED DESCRIPTION

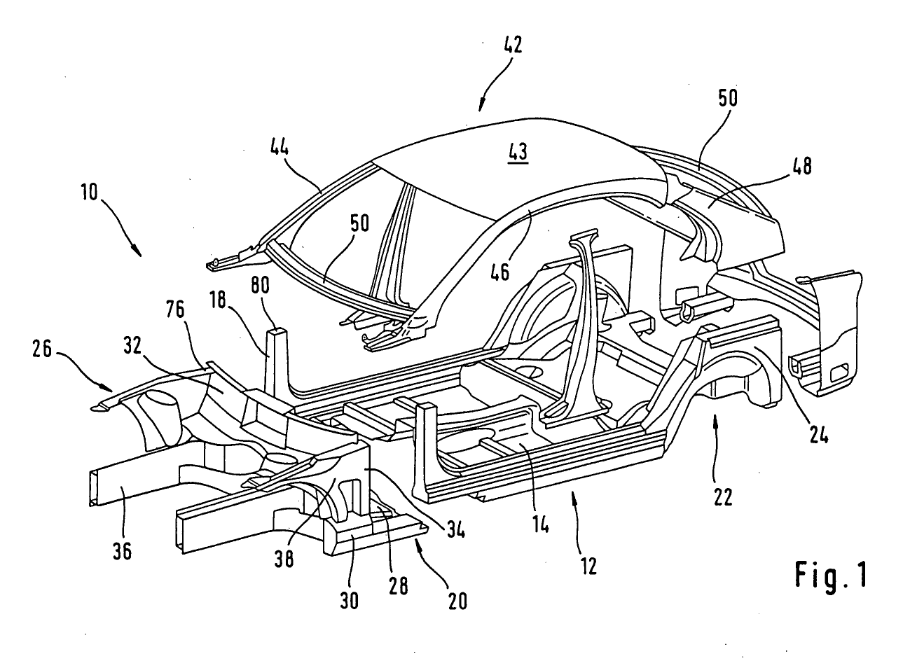

FIG. 1 shows, in a perspective exploded illustration, a support structure 10 of a motor vehicle body which is assembled from a plurality of large-size partial modules which are described in more detail below. In the exemplary embodiment shown here, the partial modules of the support structure 10 are produced in each case from a plurality of sheet-metal parts which are joined together; at the same time, however, the partial modules may also be premanufactured in different constructions, for example as a “space frame”, as plastic parts, metal cast parts, as components in a “sandwich construction” or the like. In particular, combinations of different constructions for the partial modules which are fitted together are also conceivable, depending on the application and loading. The individual modules are connected in particular via bonding connections, welding connections or the like. At the same time, other customary connections, such as screw connections or the like are conceivable.

A basic module 12 of the support structure 10 essentially comprises a body floor 14 which is bounded laterally by longitudinal members 16. The basic module 12 reaches forward as far as column sections 18 of front wall columns 20 which protrude upward from the respectively associated front ends of the lateral longitudinal members 16. The body floor 14 of the basic module 12 ends at a considerable distance behind the front end of the basic module 12 or behind the column sections 18 of the front wall columns 20. At the rear, the basic module 12 ends behind rear wheel houses 22 above which wall regions 24 of the particular rear side wall are arranged. The basic module 12 is already equipped as far as possible with the other partial modules before it is fitted together.

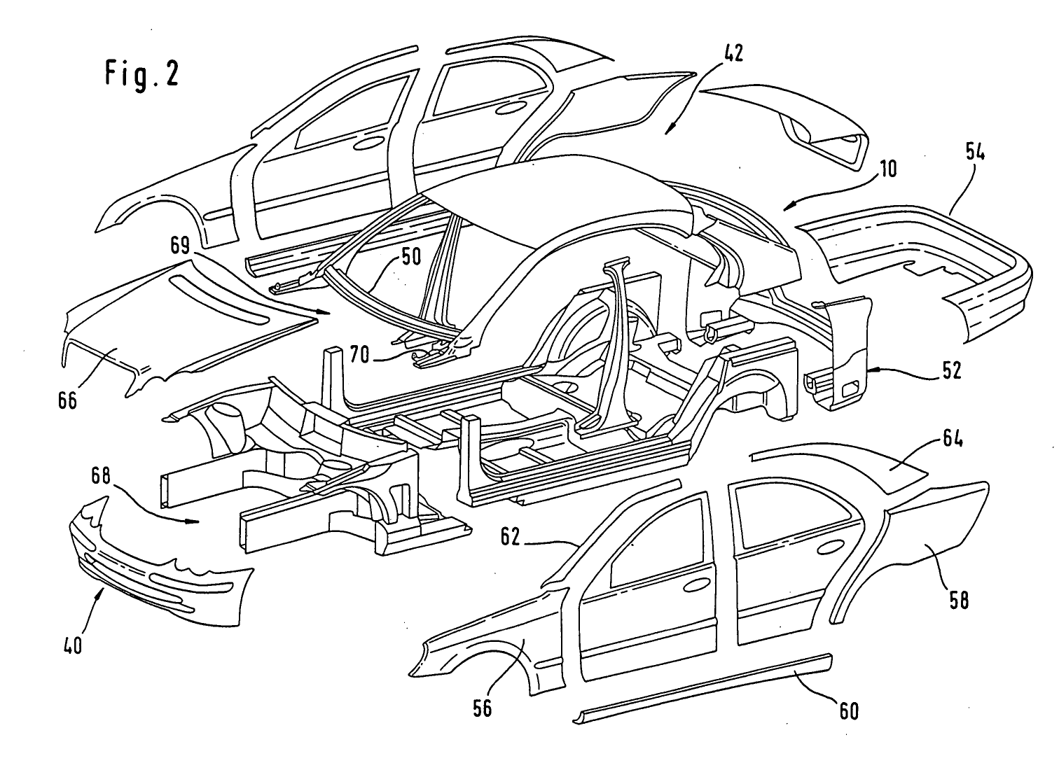

A front end module 26 which belongs to the front crumple zone of the motor vehicle and is supported in a crash stable manner on the basic module 12 is connected to the basic module 12. For this purpose, the front end module 26 comprises a front end region 28 of the body floor 14, which extends between lateral longitudinal member sections 30 of the front end module 26. At the front, the front end region 28 of the body floor 14 ends at a front end wall 32 of the passenger cell, which wall extends from the front end region 28 of the body floor 14 to approximately level with the side wall edge of the support structure 10. The end wall 32 is bounded laterally by column sections 34 of the front wall columns 20 that protrude upward from the lateral longitudinal member sections 30 of the front end module 34. At the front end of the front end module 34 front longitudinal members 36 and front side wall regions 38 can be seen. The front end module 26 is forwardly adjoined by a front module 40 which is partially illustrated in FIG. 2 and comprises, for example, the front bumper.

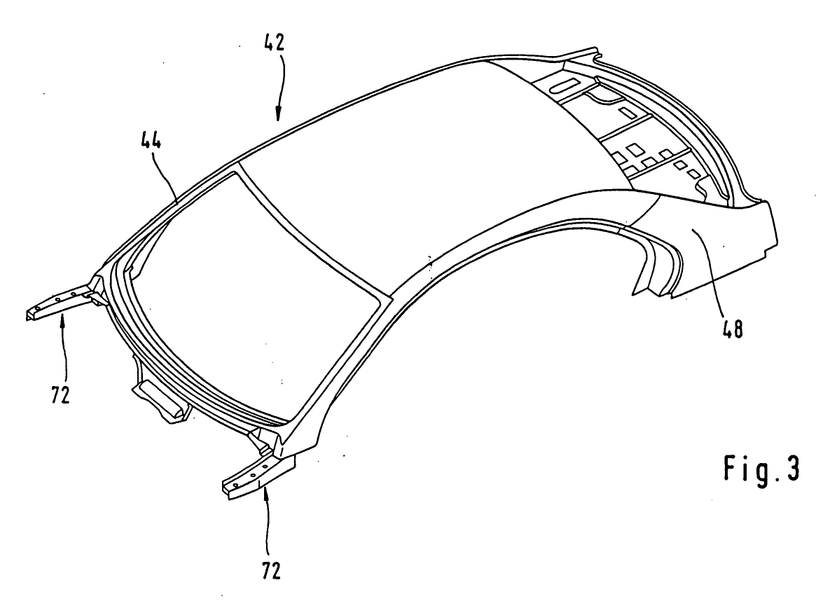

A roof module 42, which can be seen in overall view in FIG. 3, can be placed onto the basic module 12 and the front end module 26 and here comprises lateral A-columns 44, lateral roof columns 46 in the region of the roof 43, and C-columns 48. The lower ends of the A-columns 44 and of the C-columns 48 are connected to one another via a respective cross member element 50. When the support structure 10 is assembled, the A-columns 44 are supported in a manner also explained below both on the basic module 12 and on the front end module 26. At the rear, the lower ends of the C-columns 48 are supported on the respectively assigned upper end of the wall regions 24, the modules 12, 42 being connected to each other, for example, by means of a bonding connection.

At the rear, the basic module 12 is adjoined by a rear module 52 which, when the support structure 10 is assembled, belongs together with the rear end region of the basic module 12 to the rear crumple zone of the motor vehicle and bounds a trunk to the rear. To the rear, the rear module 52 is adjoined by a rear end module 54 with a rear bumper which can be partially seen in FIG. 2.

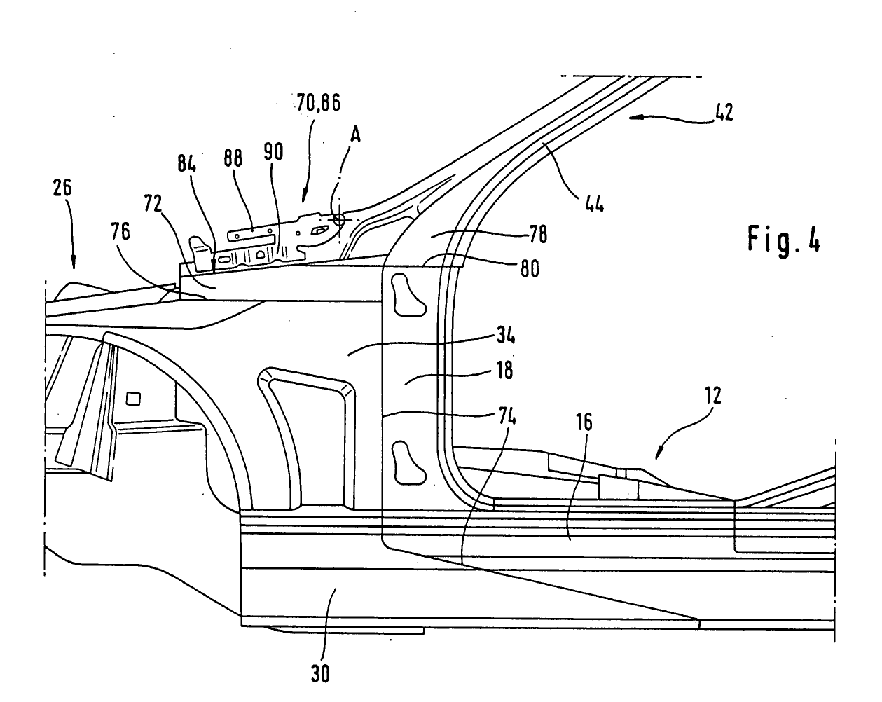

FIG. 2 illustrates, in a further perspective exploded illustration, the support structure 10 which is assembled from the partial modules 12, 26, 42 and 52 and, in the region of the front and rear wings 56, 58 and of the sill 60, is lined with outer panel parts of plastic, sheet metal or the like. The A-columns 44, the lateral roof columns 46 and the C-columns 48 are lined with column lining parts 62, 64. The roof module 42 is adjoined by a lid in the form of an engine hood 66 with which an engine compartment 68, which is provided within the front end module 26, is closed upward. In this case, the lid 66 is held in the vicinity of the roof module 42 via a bearing arrangement 69, explained in more detail with reference to FIG. 4, with two bearings 70.

The roof module 42 can be seen in a perspective view of FIG. 3, the front roof columns 44 of which are provided at their lower end with bearing consoles 72 on which the bearings 70 of the engine hood 66 are supported. The bearing consoles 72 may be produced, for example, from a box profile.

FIG. 4 shows an enlarged side view of a bearing 70 of the bearing arrangement 69 for the engine hood 66 at the lower end of the A-column 44 of the roof module 42. From the basic module 12, the longitudinal member 16 and the upwardly protruding column section 18 are connected along a joining surface 74 to the longitudinal member section 30 and, respectively, to the column section 34 of the front end module 26. In this case, the longitudinal member sections 16, 30 and the column sections 18, 34 of the basic module 12 and of the front end module 26 each have a cross-sectionally closed box profile, so that, after the box profiles assigned to one another in each case have been joined together, lateral longitudinal members 16 and door columns 20 having a doubled box profile, which is doubled in cross section and is approximately 8-shaped, are produced.

The two A-columns 44 of the roof module 42 are supported on supporting surfaces 76 of the front end module 26 via the bearing consoles 72 and are supported on supporting surfaces 80 of the basic module 12 via rear, lower end sections 78 of the roof columns 44. In this case, the supporting surfaces 80 of the basic module 12 are formed by the upper ends of the column sections 18. The respective supporting surfaces 76, 80 of the front end module 26 and of the basic module 12 are arranged offset in height with respect to one another. In this case, the bearing consoles 72 are fastened on the associated supporting surfaces 76 and the end sections 78 are fastened on the associated supporting surfaces 80 preferably by a bonding connection, with it being possible in addition for mechanical connections to be provided.

The bearings 70 of the lid are supported on the upper side 84, which is flat here, of the bearing consoles 72, said bearings here essentially in each case comprising a hinge 86 with which the lid 66 is mounted pivotably about the pivot axis A on the support structure 10. The hinge 86 comprises a hinge part 88 which can be connected to the lid 66, and a hinge part 90 which is fastened on the bearing console 72. A screw connection, with which the hinge 86 or the lid 66 can be adjusted relative to the roof module 42, is particularly suitable for fastening the hinge part 90 on the bearing console 72.

Also to be considered as being included within the scope of the invention is the fact that, in addition to the mounting (shown here) of the engine hood, the bearing arrangement is, of course, also suitable for the arrangement of other lids, for example of the trunk lid, on the roof module 42.

1-10. (canceled)

11. A motor vehicle body, comprising:
a supporting structure;
a roof module placed onto the supporting structure;
a lid to which the roof module is adjoined and for closing a space on an end region of the body;
a bearing arrangement by which the lid is arranged directly on the roof, the lid being prefitted to the roof module before the roof module is placed onto the supporting structure;
a plurality of bearing consoles for the bearing arrangement, each one of the bearing consoles being provided at lower ends of roof columns of the roof module; and
a plurality of door columns, wherein the roof columns are supported on supporting surfaces of the door columns, and the bearing consoles are supported on supporting surfaces of the supporting structure, wherein:
each door columns is joined together from two column sections,
the roof columns are supported on the respectively associated supporting surfaces of a first of the respective column sections, and
the bearing consoles are supported on the respectively associated support surfaces of a further one of the column sections.

12. The body as claimed in claim 11, wherein the further column sections are assigned to a front end module of the supporting structure.

13. The body as claimed in claim 12, wherein the further column sections protrude upward from lateral longitudinal member sections of the front end module.

14. The body as claimed in claim 11, wherein the supporting surfaces of the first column sections and the further column sections are arranged offset in height with respect to one another.

15. The body as claimed in claim 11, wherein a respectively assigned bearing of the lid is supported on the bearing consoles.

16. The body as claimed in claim 15, wherein the bearings in each case includes a hinge with which the lid is mounted pivotably on the supporting structure.
